(19) United States
(12) Patent Application Publication
(10) Pub. No.: US 2022/0375281 A1
(43) Pub. Date: Nov. 24, 2022

(54) ADAS SYSTEM CALIBRATION GUIDING METHOD AND APPARATUS, AND VEHICLE DIAGNOSIS DEVICE

(71) Applicant: AUTEL INTELLIGENT TECHNOLOGY CORP., LTD., Shenzhen (CN)

(72) Inventor: Yunyan HUANG, Shenzhen (CN)

(21) Appl. No.: 17/815,656

(22) Filed: Jul. 28, 2022

Related U.S. Application Data
(63) Continuation of application No. PCT/CN2021/071756, filed on Jan. 14, 2021.

(30) Foreign Application Priority Data
Feb. 11, 2020 (CN) 202010087080.4

(51) Int. Cl. G07C 5/08; B60W 40/12

(52) U.S. Cl. CPC G07C 5/0816; G07C 5/0808; B60W 40/12; B60W 2554/4041

(57) ABSTRACT

The present invention relates to the technical field of device calibration, and in particular to an ADAS system calibration guiding method and apparatus, and a vehicle diagnosis device. The method comprises: after a calibration request from a user for an ADAS system of a vehicle is received, prompting the user to select a maintenance scenario for calibrating the ADAS system; according to the maintenance scenario selected by the user, determining the ADAS system to be calibrated in the maintenance scenario, and giving a prompt regarding a calibration tool required for calibrating the ADAS system to be calibrated; giving a prompt regarding a positioning method for the calibration tool: after an indication of the user that the positioning of the calibration tool is completed is received, instructing the vehicle to calibrate the ADAS system to be calibrated; and acquiring a calibration result of the ADAS system to be calibrated, and outputting a calibration analysis report according to the calibration result. According to the method, the apparatus, and the vehicle diagnosis device provided by the embodiments of the present invention, the user can easily and efficiently complete the calibration of the ADAS system within a short time, thereby improving the efficiency and the convenience of the calibration of the ADAS system.

### CROSS REFERENCE

The present application is a continuation of International Patent Application No. PCT/CN2021/071756 filed on Jan. 14, 2021, which claims the priority to the Chinese patent application No. 202010087080.4 entitled “ADAS System Calibration Guiding Method and Apparatus, and Vehicle Diagnosis Device” filed on Feb. 11, 2020, to the China National Intellectual Property Administration, the entire contents of both are incorporated herein by reference.

### TECHNICAL FIELD

The present application relates to the technical field of device calibration, and more particularly to an ADAS system calibration guiding method and apparatus, and a vehicle diagnosis device.

### BACKGROUND ART

With the development of the vehicle industry and the advancement of science and technology, people have higher requirements for the safety and comfort of vehicle driving. Unmanned driving is an important direction of the current vehicle technology development. The Advanced Driver Assistance Systems (ADAS) is the early stage of the development of unmanned driving technology, which is also a necessary stage. With the increasing emphasis on vehicle safety, more and more vehicles are equipped with the ADAS system. In the near future, the ADAS system will become the standard configuration on all vehicles.

At present, the loading rate and complexity of the ADAS system are gradually increasing. The core principle of ADAS is to use a variety of radars and cameras installed on a vehicle to assist the safe driving of the vehicle through the information provided by these sensors. When each sensor is abnormal or changes the position thereof, a calibration tool dedicated to the ADAS function is required for maintenance, especially for smart calibration detections. The ADAS smart detection and calibration device is an indispensable part of vehicle smart driving and vehicle networking.

The installation of an ADAS system requires the use of sensors such as radar and a camera. Since these sensors require high precision and must be safe and accurate, the calibration of these sensors becomes complicated and difficult. However, due to the large number of manufacturers producing such sensors and the different types of sensors, the methods and tools for ADAS calibration are also different. Therefore, there is an urgent need for a convenient way to achieve ADAS system calibration.

### SUMMARY OF THE INVENTION

The technical problem to be solved by the present invention is to provide an ADAS system calibration guiding method and apparatus, and a vehicle diagnosis device so as to improve the convenience of ADAS system calibration.

In one aspect of an embodiment of the present invention, there is provided an ADAS system calibration guiding method, the method being applied to a vehicle diagnosis device. The method comprises:

after a calibration request from a user for an ADAS system of a vehicle is received, prompting the user to select a maintenance scenario for calibrating the ADAS system;

according to the maintenance scenario selected by the user, determining the ADAS system to be calibrated in the maintenance scenario, and giving a prompt regarding a calibration tool required for calibrating the ADAS system to be calibrated;

giving a prompt regarding a positioning method for the calibration tool;

after an indication of the user that the positioning of the calibration tool is completed is received, instructing the vehicle to calibrate the ADAS system to be calibrated;

and acquiring a calibration result of the ADAS system to be calibrated, and outputting a calibration analysis report according to the calibration result.

Optionally, prompting the user to select a maintenance scenario for calibrating the ADAS system comprises:

displaying at least one maintenance scenario corresponding to the vehicle on a page where the user requests ADAS system calibration to prompt the user to select a maintenance scenario for calibrating the ADAS system from the at least one maintenance scenario.

Optionally, before the giving a prompt regarding a positioning method for the calibration tool, the method further comprises:

giving a prompt regarding calibration preparation, wherein the calibration preparation is used for making the vehicle meet an ADAS system calibration requirement.

Optionally, giving a prompt regarding a positioning method for the calibration tool comprises:

prompting a positioning method for the calibration tool by means of video learning or software guiding.

Optionally, acquiring a calibration result of the ADAS system to be calibrated, and outputting a calibration analysis report according to the calibration result include:

acquiring a calibration result of the ADAS system to be calibrated;

and detecting whether the calibration result of the ADAS system is successful;

wherein if the calibration is successful, output a calibration analysis report; if the calibration fails, prompt a reason for a failure.

In another aspect of an embodiment of the present invention, there is provided an ADAS system calibration guiding apparatus, the apparatus being applied to a vehicle diagnosis device. The apparatus comprises:

a first prompt module for, after a calibration request from a user for an ADAS system of a vehicle is received, prompting the user to select a maintenance scenario for calibrating the ADAS system;

a first processing module for, according to the maintenance scenario selected by the user, determining the ADAS system to be calibrated in the maintenance scenario, and giving a prompt regarding a calibration tool required for calibrating the ADAS system to be calibrated;

a second prompt module for giving a prompt regarding a positioning method for the calibration tool;

a second processing module for, after an indication of the user that the positioning of the calibration tool is completed is received, instructing the vehicle to calibrate the ADAS system to be calibrated;

and a third processing module for acquiring a calibration result of the ADAS system to be calibrated, and outputting a calibration analysis report according to the calibration result.

Optionally, the first prompt module is specifically used for:

upon receiving a calibration request from the user for the ADAS system of the vehicle, displaying at least one maintenance scenario corresponding to the vehicle on a page where the user requests ADAS system calibration to prompt the user to select a maintenance scenario for calibrating the ADAS system from at least one maintenance scenario.

Optionally, the apparatus further comprises:

a third prompt module for prompting calibration preparation for the vehicle to meet ADAS system calibration requirements.

Optionally, the second prompt module is specifically used for:

prompting a positioning method for the calibration tool by means of video learning or software guiding.

Optionally, the third processing module is specifically used for:

acquiring a calibration result of the ADAS system to be calibrated;

and detecting whether the calibration result of the ADAS system is successful;

wherein if the calibration is successful, output a calibration analysis report; if the calibration fails, prompt a reason for a failure.

In still another aspect of an embodiment of the present invention, there is provided a vehicle diagnosis device including: at least one processor; and a memory communicatively connected to the at least one processor; wherein the memory stores instructions executable by the at least one processor, the instructions being executed by the at least one processor to enable the at least one processor to execute the ADAS system calibration guiding method as described above.

Different from the prior art, an embodiment of the present invention provides an ADAS system calibration guiding method and an apparatus, and a vehicle diagnosis device, including: after a calibration request from a user for an ADAS system of a vehicle is received, prompting the user to select a maintenance scenario for calibrating the ADAS system; according to the maintenance scenario selected by the user, determining the ADAS system to be calibrated in the maintenance scenario, and giving a prompt regarding a calibration tool required for calibrating the ADAS system to be calibrated; then giving a prompt regarding a positioning method for the calibration tool: after an indication of the user that the positioning of the calibration tool is completed is received, instructing the vehicle to calibrate the ADAS system to be calibrated; and finally, acquiring a calibration result of the ADAS system to be calibrated, and outputting a calibration analysis report according to the calibration result. The implementation mode can display the integrated calibration guiding steps on the vehicle diagnosis device and guide the user to calibrate the ADAS system through graphics and texts so that the user can easily and efficiently complete the ADAS system calibration in a short time, and improve the efficiency and convenience of ADAS system calibration.

### BRIEF DESCRIPTION OF THE DRAWINGS

One or more embodiments are illustrated by way of examples with a figure in the corresponding drawings. The illustrative examples are not to be construed as limiting the embodiments. In the drawings, elements having the same reference numeral designations represent like elements, and unless otherwise specified, the drawings are not to scale.

FIG. 1 is a flowchart of an ADAS system calibration guiding method according to an embodiment of the present invention;

FIG. 2 is a flowchart of a method for acquiring a calibration result of the ADAS system to be calibrated, and outputting a calibration analysis report according to the calibration result according to an embodiment of the present invention;

FIG. 3 is a flowchart of an ADAS calibration guiding method for a vehicle-mounted radar according to an embodiment of the present invention;

FIG. 4 is a flowchart of a method for determining a function marking point according to the calibration tool according to an embodiment of the present invention;

FIGS. 5a to 5d are schematic views of software interfaces corresponding to a method for obtaining the first function marking point m according to an embodiment of the present invention;

FIG. 6 is a flowchart of a method for determining an initial position of a reflecting mirror according to a calibration main frame and a horizontal bead according to an embodiment of the present invention;

FIGS. 7a and 7b are schematic views of software interfaces corresponding to a method for calibrating an initial position of a reflecting mirror according to an embodiment of the present invention;

FIG. 8 is a flowchart of a method for executing a preset ACC calibration operation on the reflecting mirror according to an embodiment of the present invention;

FIGS. 9a to 9f are schematic views of software interfaces corresponding to a method for calibrating a marking result according to a reflecting mirror according to an embodiment of the present invention;

FIG. 10 is a schematic structural view of a calibration guiding apparatus for an ADAS system according to an embodiment of the present invention;

FIG. 11 is a schematic structural view of a hardware of a vehicle diagnosis device according to an embodiment of the present invention.

### DETAILED DESCRIPTION OF THE INVENTION

In order that the object, technical solution, and advantages of the present invention may be more clearly understood, the present invention will now be described in further detail with reference to the accompanying drawings and embodiments. It should be understood that the particular embodiments described herein are illustrative only and are not restrictive to the present invention.

It should be noted that various features of the embodiments of the present invention can be combined with each other without conflict within the scope of the present invention. In addition, although the division of functional modules is illustrated in a schematic diagram of an apparatus and a logical order is illustrated in a flowchart, in some cases, the steps illustrated or described may be executed in an order other than shown in the flowchart and a division of modules other than illustrated in the schematic views of the apparatus.

Embodiments of the present invention provide an ADAS system calibration guiding method and apparatus, and a vehicle diagnostic device that can help guide a user to calibrate an ADAS system for various vehicle systems. According to the method, by collecting the ADAS system calibration information of a vehicle, analyzing the ADAS system calibration method for various vehicle systems according to the calibration information, integrating the calibration tool, the calibration guiding method, and the calibration software, displaying the integrated calibration guiding steps of the ADAS system on the vehicle diagnosis device, and guiding the user to calibrate the ADAS system with graphics and texts, the user can complete the calibration step by step according to the prompt information of the diagnostic software. The implementation mode integrates all the information required in the ADAS calibration process, without requiring the user to additionally learn and query other relevant data so that the ADAS system calibration process becomes simple, improving the efficiency of vehicle maintenance and improving the user experience.

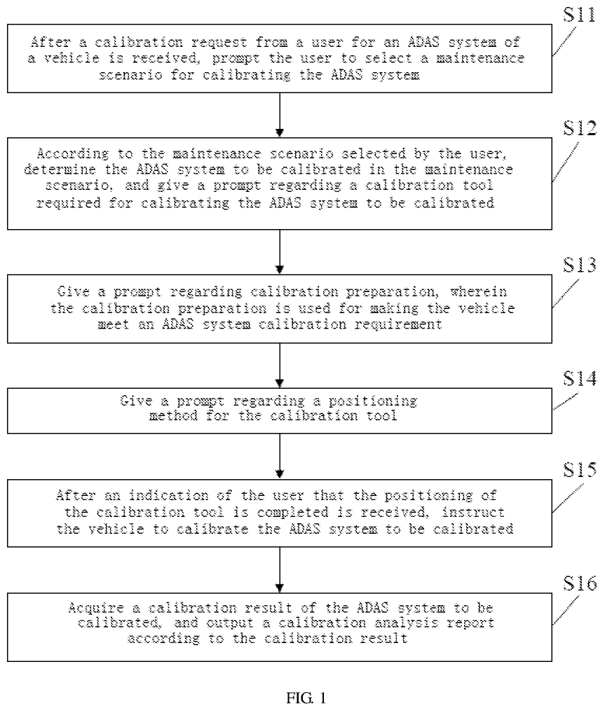

Specifically, referring to FIG. 1, FIG. 1 is a flowchart of an ADAS system calibration guiding method according to an embodiment of the present invention. The method may be applied to a vehicle diagnosis device, the method comprising:

S11, after a calibration request from a user for an ADAS system of a vehicle is received, prompt the user to select a maintenance scenario for calibrating the ADAS system.

In this embodiment, the user may actively request ADAS system calibration, and may request the ADAS system calibration for a vehicle in the event of a fault or abnormality occurring to the vehicle. The vehicle diagnosis device acquires all the ADAS systems of the vehicle according to the vehicle information about the vehicle and displays all the ADAS systems to a user. The user sends a user instruction according to the displayed ADAS system so that the vehicle diagnosis device performs calibration on the ADAS systems of the vehicle according to the user instruction, the user instruction being the calibration request. In some embodiments, after displaying all the ADAS systems to a user, the vehicle diagnosis device is further used for performing a scanning operation on all the ADAS systems to determine a failed ADAS system. The failed ADAS system correspondingly displays a fault code, and the user can send a calibration request to the ADAS system of the vehicle according to the fault code.

Prompting the user to select a maintenance scenario for calibrating the ADAS system comprises: displaying at least one maintenance scenario corresponding to the vehicle on a page where the user requests ADAS system calibration to prompt the user to select an ADAS system calibrated maintenance scenario from the at least one maintenance scenario. The maintenance scenarios refer to scenarios after the vehicle has been maintained, such as the removal or replacement of a night vision system camera, the removal or replacement of a bumper or a radiator grille, the adjustment of a chassis, the change in the height of a vehicle body, the change in the position of the night vision system camera relative to the vehicle body, etc.

The ADAS system includes adaptive cruise control, a lane departure warning system, a lane-keeping system, a lane change auxiliary system, a blind spot monitoring system, a night vision system, a panoramic 3600 surrounding system, a rear-view camera system, a headlight system, a head-up display system, a pre-crash system, an automatic braking system, a pedestrian protection system, a traffic signal recognition system, etc. The number and types of the ADAS systems assembled are different for different vehicle models, and the ways to calibrate the ADAS systems may also be different. But there is also a correlation between different ADAS systems, and the same ADAS sensor can be used to execute the corresponding work between different systems. For example, all of the lane-keeping system, the pedestrian protection system, and the traffic signal recognition system can implement their functions via a front camera; both the adaptive cruise control and the pre-crash system realize their functions via an adaptive cruise radar.

S12, according to the maintenance scenario selected by the user, determine the ADAS system to be calibrated in the maintenance scenario, and give a prompt regarding a calibration tool required for calibrating the ADAS system to be calibrated.

Different maintenance scenarios may correspond to different ADAS systems or the same ADAS system. All maintenance scenarios corresponding to the vehicle, an ADAS system corresponding to each maintenance scenario, and a calibration tool corresponding to the ADAS system can be acquired in advance.

The user-selected maintenance scenario may be one maintenance scenario or multiple maintenance scenarios.

The calibration tool refers to a tool required to be used to calibrate the ADAS system, such as a calibration main frame, a laser, a laser auxiliary mirror, a laser reflecting baffle, chalk, a tape, etc. When giving a prompt regarding a calibration tool required for calibrating the ADAS system to be calibrated, the calibration tool required for calibrating the ADAS system to be calibrated can be specifically prompted by at least one of the texts, graphics, icons, animations, videos, and audio. When there are multiple application scenarios selected by the user, the calibration tools required for calibrating the ADAS system corresponding to the application scenarios can be respectively displayed according to the application scenarios. The prompted calibration tool includes the name, model, picture, etc. of the calibration tool.

S14, give a prompt regarding a positioning method for the calibration tool.

The positioning method for the calibration tool is used for guiding a user to perform the placement of the calibration tool, the determination of parameters of the calibration tool, etc. The positioning method for the calibration tool may be prompted by means of video learning or software guiding. Specifically, the user can select to click the video button to view the method for placing the ADAS calibration tool, and click the installation button to complete the placement of the calibration tool step by step through the guiding graphic-text prompt of the software.

The positioning method further comprises detecting whether the positioning result of the calibration tool is accurate, such as detecting whether the positioning tool is correctly positioned, detecting whether the parameter of the positioning tool is accurate, etc. Visual control, image recognition, millimeter wave detection, laser detection and other technologies can be used to detect whether the positioning result of a calibration tool is accurate. If the positioning result of the calibration tool is abnormal, the user may be prompted to adjust the placement position of the positioning tool or the parameters of the positioning tool, etc. If the positioning result of the calibration tool meets the requirements, the user may send a confirmation instruction indicating that the calibration tool positioning is completed.

S15, after an indication of the user that the positioning of the calibration tool is completed is received, instruct the vehicle to calibrate the ADAS system to be calibrated.

The user may click a “confirm” button to indicate that the positioning of the calibration tool is completed. The indication that the vehicle calibrates the ADAS system to be calibrated is to use a diagnostic instrument to drive the vehicle ADAS system into a calibration mode to complete functional calibration according to the positioned calibration tool, so as to ensure that the ADAS system on the vehicle can be used safely and normally. The detailed process of calibrating the ADAS system based on the positioning tool can be referred to the prior art and will not be described further herein.

S16, acquire a calibration result of the ADAS system to be calibrated, and output a calibration analysis report according to the calibration result.

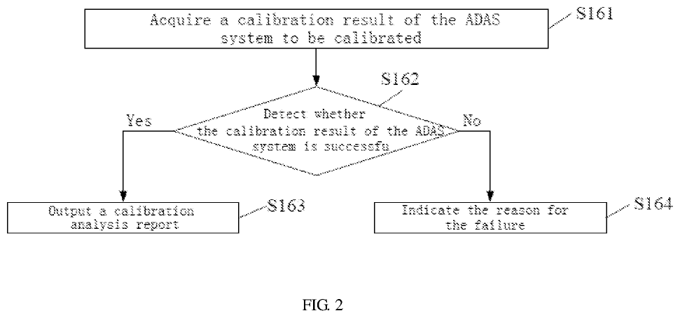

In this embodiment, referring to FIG. 2, acquiring a calibration result of the ADAS system to be calibrated, and outputting a calibration analysis report according to the calibration result include:

S16, acquiring a calibration result of the ADAS system to be calibrated;

and S162, detecting whether the calibration result of the ADAS system is successful;

wherein if the calibration is successful, the following step S163 is executed; if the calibration fails, the following step S163 is executed.

S163, output a calibration analysis report.

S164, indicate the reason for the failure.

The calibration result of the ADAS system comprises two cases: a calibration success and a calibration failure. When the calibration is successful, a calibration analysis report including the number, name, calibration status, etc. of the detected ADAS system is output. The calibration status includes whether it is calibrated, whether the calibration result is “normal” or “fault”, and the corresponding fault code of the “fault”. The calibration analysis report also includes a calibration result of the maintenance scenario. The calibrated and uncalibrated maintenance scenarios may be identified respectively. The calibration analysis report may also include parameter information used by the calibration tool during the calibration. When the calibration fails, the user may be prompted with a reason for the failure, which may be determined according to maintenance scenarios, calibration tools, etc. e. g. calibration panel over-lighting, etc. The user may resend a calibration request for an ADAS system of the vehicle according to the prompted reason for the failure. The ADAS system corresponding to the calibration request may be the ADAS system of which calibration has failed or may be all the ADAS systems of the vehicle.

In some embodiments, also referring to FIG. 1, before the prompting a positioning method for the calibration tool, the method further comprises:

S13, give a prompt regarding calibration preparation, wherein the calibration preparation is used for making the vehicle meet an ADAS system calibration requirement.

The calibration preparation comprises prompting a user of matters needing attention and work matters needing preparation before performing the positioning method for a calibration tool.

Prompt the calibration preparation so that the user can successfully complete the correct placement of positioning tools and the calibration of an ADAS system.

An embodiment of the present invention provides an ADAS system calibration guiding method, the method comprising: after a calibration request from a user for an ADAS system of a vehicle is received, prompting the user to select a maintenance scenario for calibrating the ADAS system; according to the maintenance scenario selected by the user, determining the ADAS system to be calibrated in the maintenance scenario, and giving a prompt regarding a calibration tool required for calibrating the ADAS system to be calibrated; then giving a prompt regarding a positioning method for the calibration tool: after an indication of the user that the positioning of the calibration tool is completed is received, instructing the vehicle to calibrate the ADAS system to be calibrated; and finally, acquiring a calibration result of the ADAS system to be calibrated, and outputting a calibration analysis report according to the calibration result. This method can display the integrated calibration guiding steps on the vehicle diagnosis device and guide the user to calibrate the ADAS system through graphics and texts so that the user can easily and efficiently complete the ADAS system calibration in a short time, and improve the efficiency and convenience of ADAS system calibration.

The following describes the detailed process of the above method embodiment by way of an example. It needs to be noted that the following examples are merely illustrative of the ADAS system calibration guiding method provided by embodiments of the present invention and are not intended to limit the method. The ADAS system calibration guiding method provided by the embodiments of the present invention is mainly used for guiding the process of vehicle-mounted radar calibration of a vehicle.

In the field of vehicle ADAS, the Adaptive Cruise Control (ACC) is a commonly used auxiliary function. Its specific working principle is to perform distance measurement on a preceding vehicle in real time by a vehicle-mounted radar, compare the speed of the vehicle itself with the speed of the preceding vehicle, and control the power system of the vehicle, such as the accelerator, the brake, etc. so that the vehicle always maintains a constant safe distance from the preceding vehicle.

Therefore, the function of the vehicle-mounted radar is very important in the realization of the ACC function. Apart from the measurement performance of the radar itself, its installation position and installation angle determine the correctness and accuracy of the final measured data. However, the above-mentioned installation position and installation angle may change due to uncontrollable factors such as vibration and collision caused by vehicle use. So the calibration of the vehicle-mounted radar is the core content in the field of vehicle maintenance and device calibration, especially in the calibration of the ACC function.

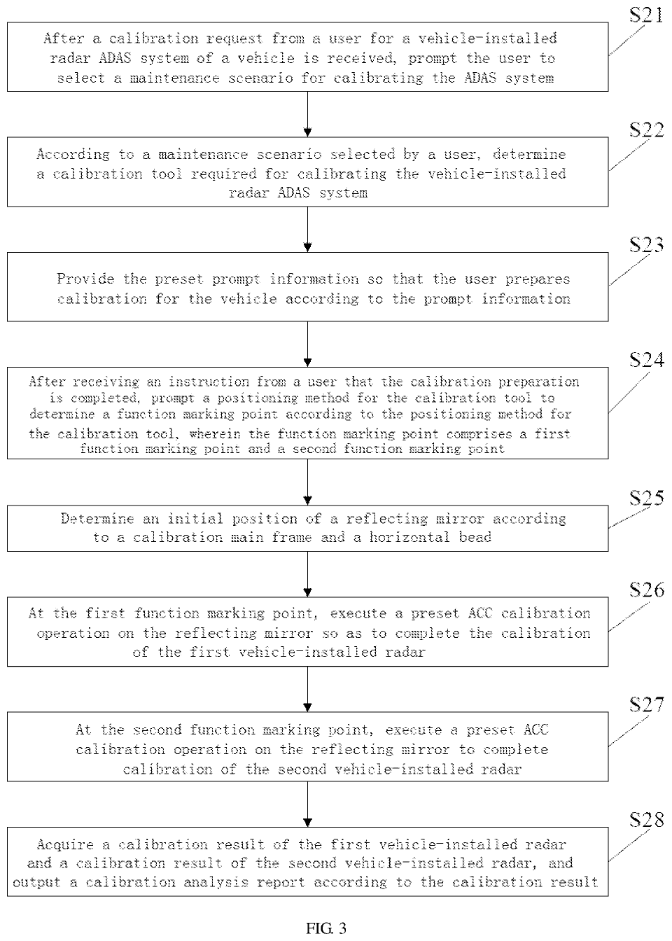

Specifically, as shown in FIG. 3, a specific process of ADAS calibration guiding for a vehicle-mounted radar includes:

S21, after a calibration request from a user for a vehicle-mounted radar ADAS system of a vehicle is received, prompt the user to select a maintenance scenario for calibrating the ADAS system.

The maintenance scenario comprises at least one of the following:

uninstalling or replacing a night vision system camera;

uninstalling or replacing the bumper or radiator grille;

adjusting the chassis;

changing the height of the vehicle body;

and changing the position of the night vision system camera relative to the vehicle body.

The user may select one or more maintenance scenarios of the above maintenance scenarios.

S22, according to a maintenance scenario selected by a user, determine a calibration tool required for calibrating the vehicle-mounted radar ADAS system.

The calibration tool comprises: a calibration main frame, a night vision calibration instrument, a two-line laser, a five-line laser, a laser reflecting baffle, a laser auxiliary mirror, a plumb line, a power adapter, chalk, a tape, etc. The name, model, picture, and other information of the calibration tool may be displayed to the user.

S23, provide the preset prompt information so that the user prepares calibration for the vehicle according to the prompt information.

The prompt information is used to prompt the user about matters needing attention and the preparation work before executing the ADAS calibration. For example, the prompt information comprises:

stopping the vehicle on level ground with the front wheels in a straight line position;

keeping the vehicle empty to ensure that the coolant and engine oil level are correct and that the fuel tank is full;

connecting the diagnostic instrument to the vehicle, wherein if a wired connection is used, the diagnostic line can pass out of the vehicle window;

tightening the parking brake and turning off all doors and external lighting;

adjusting the tire air pressure to a specified value;

placing the vehicle in a cold state; connecting the battery charger to avoid deep discharge of the battery;

visually inspect whether the night vision system camera is located in a bracket, and whether the view angle of the camera is blocked (generally, the night vision system camera is located at the inlet grid of the vehicle head or near the vehicle logo);

and inspecting whether the protective window of the night vision system camera is damaged, and replacing it if it is damaged.

The prompt information may also comprise matters needing attention, for example, reminding the user to pay attention to the position of the camera according to the actual situation. The prompt information may also comprise a key description of the diagnostic software. For example, the “install” key is used for viewing the placement step of the calibration tool, the “video” key is used for viewing the placement demonstration of the calibration tool, and the “confirm” key is used for entering a calibration program.

S24, after receiving an instruction from a user that the calibration preparation is completed, prompt a positioning method for the calibration tool to determine a function marking point according to the positioning method for the calibration tool, wherein the function marking point comprises a first function marking point and a second function marking point.

The function marking point refers to a position point for the ADAS calibration of the vehicle-mounted radar. The vehicle-mounted radar is usually installed on the left and right sides of the front of the vehicle, and distance measurement can be performed on the preceding vehicle in real time by the vehicle-mounted radar. Therefore, the function marking points include a first function marking point at which the ADAS calibration can be performed for a first vehicle-mounted radar and a second function marking point at which the ADAS calibration can be performed for a second vehicle-mounted radar. The first vehicle-mounted radar is a vehicle-mounted radar on the left side of the vehicle or a vehicle-mounted radar on the right side of the vehicle. When the first vehicle-mounted radar is a vehicle-mounted radar on the left side of the vehicle, the second vehicle-mounted radar is a vehicle-mounted radar on the right side of the vehicle; when the first vehicle-mounted radar is a vehicle-mounted radar on the right side of the vehicle, the second vehicle-mounted radar is a vehicle-mounted radar on the left side of the vehicle.

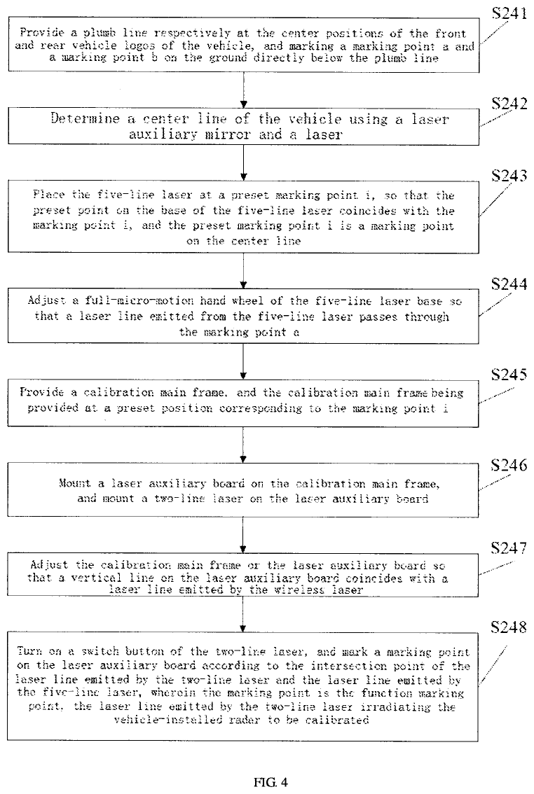

As shown in FIG. 4, determining a function marking point according to the calibration tool comprises:

S241, providing a plumb line respectively at the center positions of the front and rear vehicle logos of the vehicle, and marking a marking point a and a marking point b on the ground directly below the plumb line;

S242, determining a center line of the vehicle using a laser auxiliary mirror and a laser;

S243, placing the five-line laser at a preset marking point i, so that the preset point on the base of the five-line laser coincides with the marking point i, and the preset marking point i is a marking point on the center line;

S244, adjusting a full-micro-motion hand wheel of the five-line laser base so that a laser line emitted from the five-line laser passes through the marking point a;

S245, providing a calibration main frame, and the calibration main frame being provided at a preset position corresponding to the marking point i;

S246, installing a laser auxiliary board on the calibration main frame, and installing a two-line laser on the laser auxiliary board;

S247, adjusting the calibration main frame or the laser auxiliary board so that a vertical line on the laser auxiliary board coincides with a laser line emitted by the wireless laser;

S248, turning on a switch button of the two-line laser, and marking a marking point on the laser auxiliary board according to the intersection point of the laser line emitted by the two-line laser and the laser line emitted by the five-line laser, wherein the marking point is the function marking point, the laser line emitted by the two-line laser irradiating the vehicle-mounted radar to be calibrated;

The preset marking point i is located on the center line, which can be a point at a preset distance from the marking point a, and the preset distance can be set according to practical application scenarios, such as 1.2 meters.

The above-mentioned steps S241 to S248 serve to determine the function marking point according to a calibration tool. The left-side vehicle-mounted radar and the right-side vehicle-mounted radar of the vehicle can be calibrated respectively by moving the calibration main frame. It is mainly to place the calibration main frame at different preset positions corresponding to the marking point i, for example, the left position of the marking point i and the right position of the marking point i. When the laser auxiliary board is located at the left position of the marking point i, the function marking point is used for calibrating a left-side vehicle-mounted radar of the vehicle; when the laser auxiliary board is located at the right position of the marking point i, the function marking point is used for calibrating a right-side vehicle-mounted radar of the vehicle.

It should be noted that the calibration process and principle for the vehicle-mounted radar on the left side of the vehicle are the same as the calibration process and principle for the vehicle-mounted radar on the right side of the vehicle, except for changing the positions of the laser auxiliary board and the two-line laser installed on the calibration main frame.

In addition, the calibration main frame may not be necessary, and the laser auxiliary board may be fixed by other means, such as being held by a human hand.

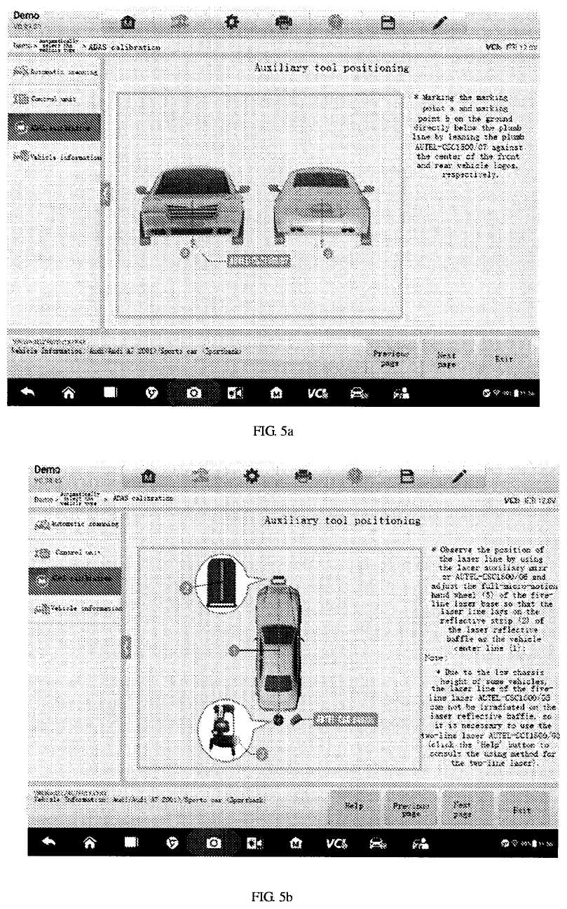

For example, referring to FIGS. 5a to 5d, FIGS. 5a to 5d are schematic views of a software interface corresponding to a method for obtaining the first function marking point m. The position of the laser line can be specifically adjusted by adjusting a full-micro-motion hand wheel of a five-line laser base so that the laser line lays on a reflective strip of a laser reflective baffle. It is also possible to adjust the position of the laser line by adjusting the two-line laser. This can be specifically selected according to the actually applied vehicle type. The preset marking point i is used for placing a five-line laser, and the marking point i can be specifically located on the center line of the vehicle, and the center line of the vehicle can be obtained according to the above-mentioned marking point a and marking point b. When the marking point i is placed on the five-line laser, the positive direction of the five-line laser (namely, one side containing the product logo position) is towards the form direction of the vehicle, and the central point of the base of the five-line laser (namely, the i point in FIG. 5c) coincides with the marking point i. After the five-line laser is placed, the full-micro-motion hand wheel of the five-line laser base is adjusted so that the laser line emitted by the five-line laser passes through the above-mentioned marking point a (the laser line is a line corresponding to 3 as shown in FIG. 5d). When the first function marking point m is to calibrate the vehicle-mounted radar on the left side in front of the vehicle, as shown in FIG. 5d, a two-line laser can be placed on the left side of the marking point i. The two-line laser is specifically installed on a laser auxiliary board, and the laser auxiliary board is arranged on the left side of the point i. Firstly, the position of the laser auxiliary board is calibrated, and the laser auxiliary board can be moved so that the vertical line of the laser auxiliary board (namely, the line corresponding to 2 shown in FIG. 5d) coincides with the laser line emitted by the above-mentioned five-line laser, and the position of the laser auxiliary board is determined at this moment. At the same time, the button switch of the two-line laser can be turned on, and the two-line laser emits a laser line which irradiates the left-side vehicle-mounted radar sensor of the vehicle; at this time, the laser line emitted by the five-line laser and the laser line emitted by the two-line laser have an intersection point, namely, a cross hole shown in FIG. 5d, and the cross hole serves as the marking point m.

The second function marking point n may also be determined according to the principle of determining the first function marking point m according to the above FIGS. 5a to 5d. A two-line laser is placed on the right side of the marking point i. The two-line laser is specifically installed on a laser auxiliary board, and the laser auxiliary board is arranged on the right side of the point i. The second function marking point n refers to a position point for calibrating the second vehicle-mounted radar. The definition of the second vehicle-mounted radar can be made with particular reference to the description of the above-mentioned procedure.

S25, determine an initial position of a reflecting mirror according to a calibration main frame and a horizontal bead.

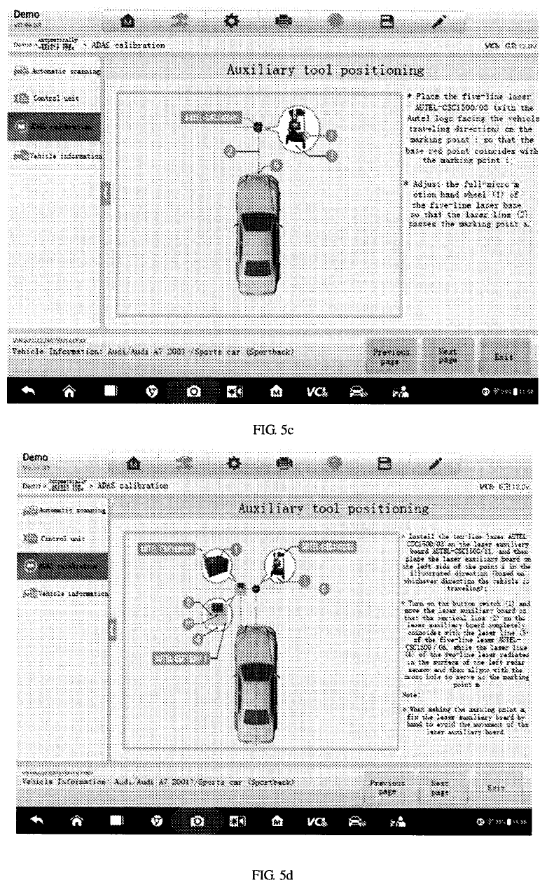

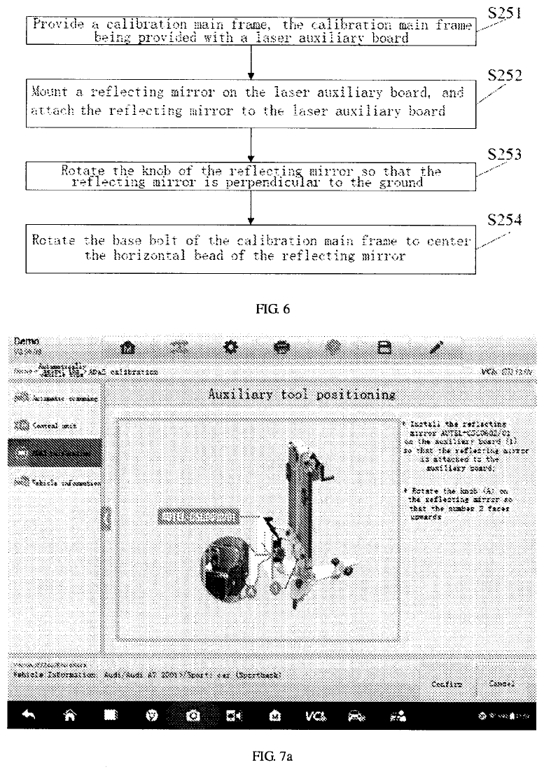

As shown in FIG. 6, determining an initial position of a reflecting mirror according to a calibration main frame and a horizontal bead comprises:

S251, providing a calibration main frame, and the calibration main frame being provided with a laser auxiliary board;

S252, installing a reflecting mirror on the laser auxiliary board, and attaching the reflecting mirror to the laser auxiliary board;

S253, rotating the knob of the reflecting mirror so that the reflecting mirror is perpendicular to the ground;

and S254, rotating the base bolt of the calibration main frame to center the horizontal bead of the reflecting mirror.

When providing the calibration main frame, it is necessary to firstly ensure that the position of the calibration main frame is set correctly, and the calibration main frame can be provided on a horizontal ground in front of the vehicle. In the above step, a two-line laser is installed on the laser auxiliary board, and here, the two-line laser can be removed first, and then the reflecting mirror is installed on the laser auxiliary board.

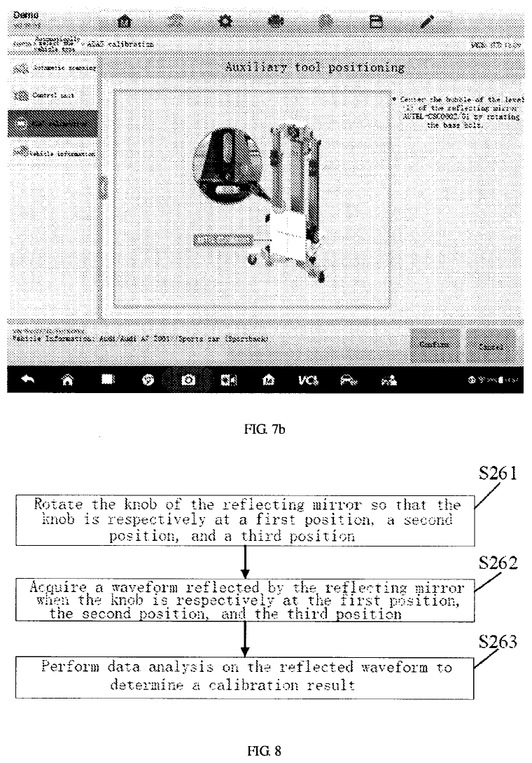

For example, referring to FIGS. 7a and 7b, in FIG. 7a, by rotating the knob of the reflecting mirror, the number 2 on the knob faces upwards, i. e. the reflecting mirror is currently in the second gear, and in FIG. 7b, the bubble of the level of the reflecting mirror is centered, i. e. the horizontal bead is centered. Therefore, the initial position of the reflecting mirror is calibrated so that it is perpendicular to the ground.

After determining the initial position of the reflecting mirror, the calibration effect of the vehicle-mounted radar is calibrated according to the reflecting mirror.

S26, at the first function marking point, execute a preset ACC calibration operation on the reflecting mirror so as to complete the calibration of the first vehicle-mounted radar.

S27, at the second function marking point, execute a preset ACC calibration operation on the reflecting mirror to complete the calibration of the second vehicle-mounted radar.

S28, acquire a calibration result of the first vehicle-mounted radar and a calibration result of the second vehicle-mounted radar, and output a calibration analysis report according to the calibration result.

Wherein, as shown in FIG. 8, executing a preset ACC calibration operation on the reflecting mirror comprises:

S261, rotating the knob of the reflecting mirror so that the knob is respectively at a first position, a second position, and a third position;

S262, acquiring a waveform reflected by the reflecting mirror when the knob is respectively at the first position, the second position, and the third position;

and S263, performing data analysis on the reflected waveform to determine a calibration result.

The first position, the second position, and the third position respectively correspond to a first gear, a second gear, and a third gear of the reflecting mirror. When the reflecting mirror is in a different gear, the reflecting mirror respectively corresponds to different angles. When executing a calibration function, the following steps are carried out: obtaining a corresponding waveform through reflecting mirrors with different angles, judging whether the calibration is completed according to the waveform, and acquiring a calibration result.

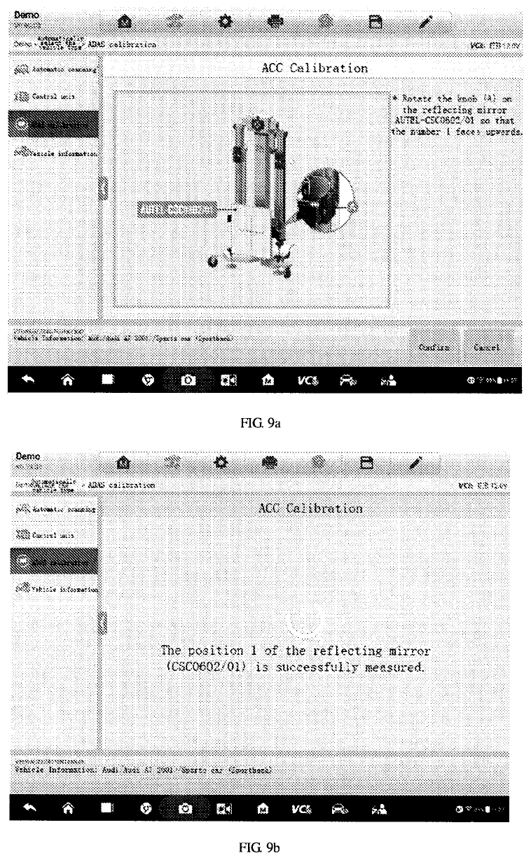

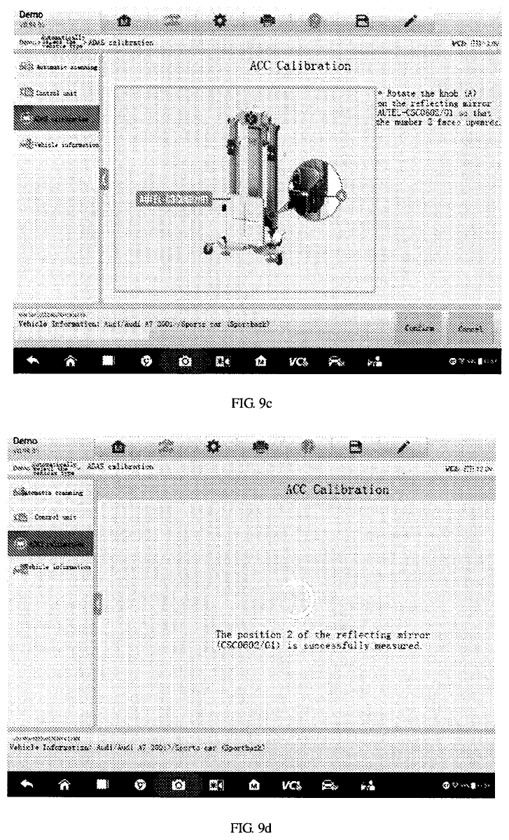

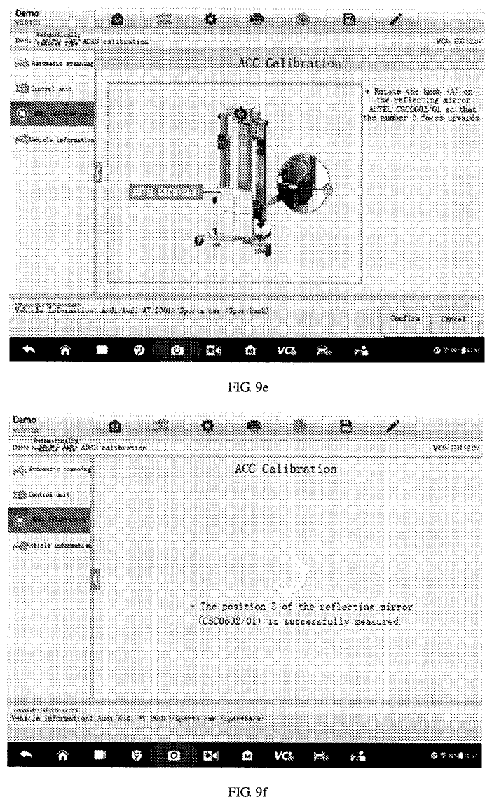

For example, referring to FIGS. 9a to 9f, there are shown the results of checking the calibration of the ADAS system according to the waveform reflected by the reflecting mirror when the knob of the reflecting mirror faces “1” upwards, “2” upwards, and “3” upwards, respectively.

The calibration result may be a successful calibration or a failed calibration. When the calibration is successful, the accurate calibration result can be fed back, and the calibration information and calibration parameters can be displayed to the user in the form of a report. The user can accurately acquire the calibration information and parameters, and can print them to the owner of the vehicle or a insurance company. When the calibration fails, prompt information can be given to help the user find out the reason for the failure, and the user can re-perform the calibration.

The embodiments of the present invention provide an ADAS system calibration guiding method. The method can instruct a user to execute a calibration function step by step by means of graph-text prompts, so that the user can easily and efficiently complete the calibration of the ADAS system in a short time, thereby improving the efficiency and convenience of the calibration of the ADAS system.

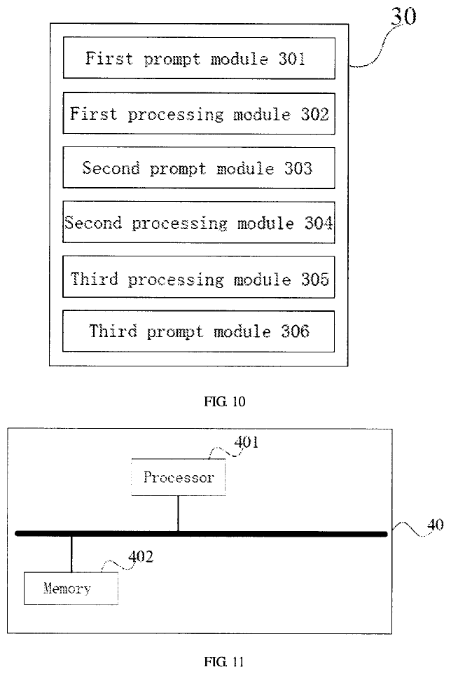

Referring to FIG. 10, FIG. 10 is a schematic structural view of a calibration guiding apparatus for an ADAS system according to an embodiment of the present invention. The apparatus 30 is applied to a vehicle diagnosis device, the apparatus 30 comprising: a first prompt module 301, a first processing module 302, a second prompt module 303, a second processing module 304, and a third processing module 305.

The first prompt module 301 is used for prompting a user to select a maintenance scenario for calibrating the ADAS system after receiving a calibration request from the user for the ADAS system of the vehicle; the first processing module 302 is used for determining an ADAS system to be calibrated in the maintenance scenario and prompting a calibration tool required to calibrate the ADAS system to be calibrated according to the maintenance scenario selected by the user; the second prompt module 303 is used for prompting a positioning method for the calibration tool; the second processing module 304 is used for instructing the vehicle to calibrate the ADAS system to be calibrated after receiving the indication by the user of the completion of positioning the calibration tool; the third processing module 305 is used for acquiring a calibration result of the ADAS system to be calibrated and outputting a calibration analysis report according to the calibration result.

The first prompt module 301 is specifically used for: upon receiving a calibration request from a user for an ADAS system of a vehicle, displaying at least one maintenance scenario corresponding to the vehicle on a page where the user requests ADAS system calibration to prompt the user to select a maintenance scenario for calibrating the ADAS system from at least one maintenance scenario.

The second prompt module 303 is specifically used for: prompting a positioning method for the calibration tool by means of video learning or software guiding.

The third processing module 305 is specifically used for:

acquiring a calibration result of the ADAS system to be calibrated;

and detecting whether the calibration result of the ADAS system is successful;

wherein if the calibration is successful, output a calibration analysis report; if the calibration fails, prompt the reason for the failure.

In some embodiments, referring also to FIG. 10, the apparatus 30 further includes a third prompt module 306. The third prompt module 306 is used to prompt calibration preparation for the vehicle to meet ADAS system calibration requirements.

It should be noted that the information interaction between the modules and units in the above-mentioned apparatus, the execution process, etc. are based on the same concept as the method embodiment of the present invention, and reference can be made to the description of the method embodiment of the present invention for details, which will not be repeated herein.

Referring to FIG. 11, FIG. 11 is a schematic structural view of a hardware of a vehicle diagnosis device according to an embodiment of the present invention. The vehicle diagnosis device can be used to execute the ADAS system calibration guiding method as described above. As shown in FIG. 11, the vehicle diagnosis device 40 includes:

one or more processors 401 and memory 402, one processor 401 being exemplified in FIG. 11.

The processor 401 and the memory 402 may be connected via a bus or otherwise, as exemplified in FIG. 11 by a bus connection.

The memory 402 is a non-volatile computer-readable storage medium that can be used to store a non-volatile software program, a non-volatile computer-executable program, and a module, such as the program instructions/modules (e. g. the modules shown in FIG. 10) corresponding to the ADAS system calibration guiding method in an embodiment of the present invention. The processor 401 executes various functional applications and data processing of the server by running the non-volatile software programs, instructions, and modules stored in the memory 402, i. e. implementing the ADAS system calibration guiding method in the method embodiment described above.

The memory 402 may comprise a program storage area and a data storage area. The program storage area may store an operating system and an application program required by at least one function; the data storage area may store, among other things, data created from the use of the ADAS system calibration guiding apparatus. In addition, memory 402 may include a high speed random access memory and may further include a non-volatile memory, such as at least one magnetic disk storage device, flash memory device, or other non-volatile solid state storage device. In some embodiments, the memory 402 may optionally include a memory remotely provided with respect to the processor 401. These remote memories may be networked to the ADAS system calibration guiding apparatus. Examples of such networks include, but are not limited to, the Internet, intranets, local area networks, mobile communication networks, and combinations thereof.

The one or more modules are stored in the memory 402 that, when executed by the one or more processors 401, execute the ADAS system calibration guiding method in any of the method embodiments described above, e. g. performing the methods described above in FIG. 1, FIG. 2, FIG. 3, FIG. 4, FIG. 6, and FIG. 8, and implement the functions of the modules in FIG. 10.

The above-mentioned product can execute the method provided by the embodiments of the present invention, and has the corresponding functional modules and beneficial effects for executing the method. Technical details not described in detail in the embodiment can be found in the method provided in the embodiments of the present invention.

Embodiments of the present invention provide a non-volatile computer-readable storage medium having stored thereon computer-executable instructions that, when executed by one or more processors, such as one processor 401 of FIG. 11, may cause the one or more processors to execute the ADAS system calibration guiding method for any of the method embodiments described above, such as the method for FIG. 1, FIG. 2, FIG. 3, FIG. 4, FIG. 6, and FIG. 8 described above, and to implement the functions of the modules of FIG. 10.

Embodiments of the present invention provide a computer program product comprising a computer program stored on the non-volatile computer-readable storage medium, the computer program comprising program instructions which, when executed by a computer, cause the computer to execute the ADAS system calibration guiding method in any of the method embodiments described above, for example, to execute the method for FIG. 1, FIG. 2, FIG. 3, FIG. 4, FIG. 6, and FIG. 8 described above, and to implement the functions of the modules of FIG. 10.

The above-mentioned apparatus embodiments are merely schematic, wherein the units illustrated as separate parts may or may not be physically separated, and the parts shown as units may or may not be physical units, i. e. may be located in one place, or may also be distributed over multiple network units. Some or all modules may be selected to achieve the object of the embodiments and solutions according to actual needs.

From the above description of the implementation mode, it will be clear to a person skilled in the art that the implementation modes can be implemented by means of software plus a general purpose hardware platform, and can of course also be implemented by means of hardware. It will be appreciated by those of ordinary skill in the art that the implementation of all or part of the flow of the methods of the above embodiments may be accomplished by a computer program instructing related hardware. The program can be stored on a computer-readable storage medium.

The program, when executed, can include the flow of the embodiments of various methods mentioned above. The storage medium may be a magnetic disk, an optical disk, a Read-Only Memory (ROM), or a Random Access Memory (RAM), etc.

Finally, it should be noted that: the above embodiments are merely illustrative of the technical solutions of the present invention, rather than limiting thereto; combinations of technical features in the above embodiments or in different embodiments are also possible within the idea of the present invention, and the steps can be implemented in any order, and there are many other variations of the different aspects of the present invention as described above, which are not provided in detail for the sake of brevity; although the present invention has been described in detail with reference to the foregoing embodiments, those of ordinary skills in the art will appreciate that: the technical solutions disclosed in the above-mentioned embodiments can still be modified, or some of the technical features can be replaced by equivalents; such modifications and substitutions do not depart the essence of corresponding technical solutions from the scope of the technical solutions of various embodiments of the present invention.

1. An ADAS system calibration guiding method, being applied to a vehicle diagnosis device, the method comprising:
after a calibration request from a user for an ADAS system of a vehicle is received, prompting the user to select a maintenance scenario for calibrating the ADAS system;
according to the maintenance scenario selected by the user, determining the ADAS system to be calibrated in the maintenance scenario, and giving a prompt regarding a calibration tool required for calibrating the ADAS system to be calibrated;
giving a prompt regarding a positioning method for the calibration tool;
after an indication of the user that the positioning of the calibration tool is completed is received, instructing the vehicle to calibrate the ADAS system to be calibrated; and
acquiring a calibration result of the ADAS system to be calibrated, and outputting a calibration analysis report according to the calibration result.

2. The method according to claim 1, wherein prompting the user to select a maintenance scenario for calibrating the ADAS system comprises:
displaying at least one maintenance scenario corresponding to the vehicle on a page where the user requests ADAS system calibration to prompt the user to select a maintenance scenario for calibrating the ADAS system from the at least one maintenance scenario.

3. The method according to claim 1, wherein before giving a prompt regarding a positioning method for the calibration tool, the method further comprises:
giving a prompt regarding calibration preparation, wherein the calibration preparation is used for making the vehicle meet an ADAS system calibration requirement.

4. The method according to claim 1, wherein the giving a prompt regarding a positioning method for the calibration tool comprises:
prompting a positioning method for the calibration tool by means of video learning or software guiding.

5. The method according to claim 1, wherein acquiring a calibration result of the ADAS system to be calibrated and outputting a calibration analysis report according to the calibration result comprises:
acquiring a calibration result of the ADAS system to be calibrated; and
detecting whether the calibration result of the ADAS system is successful;
wherein if the calibration is successful, output a calibration analysis report; if the calibration fails, prompt a reason for a failure.

6. A vehicle diagnosis device, comprising:
at least one processor;
and a memory communicatively connected to the at least one processor;
wherein the memory stores instructions executable by the at least one processor, the instructions being executed by the at least one processor to enable the at least one processor to execute a method comprising steps of:
after a calibration request from a user for an ADAS system of a vehicle is received, prompting the user to select a maintenance scenario for calibrating the ADAS system;
according to the maintenance scenario selected by the user, determining the ADAS system to be calibrated in the maintenance scenario, and giving a prompt regarding a calibration tool required for calibrating the ADAS system to be calibrated;
giving a prompt regarding a positioning method for the calibration tool;
after an indication of the user that the positioning of the calibration tool is completed is received, instructing the vehicle to calibrate the ADAS system to be calibrated; and
acquiring a calibration result of the ADAS system to be calibrated, and outputting a calibration analysis report according to the calibration result.

7. The vehicle diagnosis device according to claim 6, wherein when the at least one processor executes the step of prompting the user to select a maintenance scenario for calibrating the ADAS system, the at least one processor specifically executes a step of:
displaying at least one maintenance scenario corresponding to the vehicle on a page where the user requests ADAS system calibration to prompt the user to select a maintenance scenario for calibrating the ADAS system from the at least one maintenance scenario.

8. The vehicle diagnosis device according to claim 6, wherein before the at least one processor executes the step of giving a prompt regarding a positioning method for the calibration tool, the at least one processor further executes a step of:
giving a prompt regarding calibration preparation, wherein the calibration preparation is used for making the vehicle meet an ADAS system calibration requirement.

9. The vehicle diagnosis device according to claim 6, wherein when the at least one processor executes the step of giving a prompt regarding a positioning method for the calibration tool, the at least one processor specifically executes a step of:
prompting a positioning method for the calibration tool by means of video learning or software guiding.

10. The vehicle diagnosis device according to claim 6, wherein when the at least one processor executes the step of acquiring a calibration result of the ADAS system to be calibrated and outputting a calibration analysis report according to the calibration result, the at least one processor further executes steps of:
acquiring a calibration result of the ADAS system to be calibrated; and
detecting whether the calibration result of the ADAS system is successful;
wherein if the calibration is successful, output a calibration analysis report; if the calibration fails, prompt a reason for a failure.
